(19) United States
(12) Patent Application Publication
(10) Pub. No.: US 2013/0046759 A1
(43) Pub. Date: Feb. 21, 2013

(54) CONNECTING QUESTIONS, ANSWERS, ANNOUNCEMENTS AND ACTIVITIES TO RELEVANT ENTITIES

(71) Applicants: Leo Grady, Yardley, PA (US); Mathäus Dejori, New York, NY (US)

(72) Inventors: Leo Grady, Yardley, PA (US); Mathäus Dejori, New York, NY (US)

(73) Assignee: Siemens Corporation, Iselin, NJ (US)

(21) Appl. No.: 13/209,622

(22) Filed: Aug. 15, 2011

(51) Int. Cl. G06F 17/30

(52) U.S. Cl. 707/728; 707/E17.014

(57) ABSTRACT

A method for brokering information includes receiving an initiator produced system activity, scoring a relevance of the system activity with each of a plurality of subscriber-specified thresholds, and transmitting an activity response to a subscriber activity feed in response to the system activity, the subscriber activity feed selected according to the relevance of a corresponding subscriber-specified threshold.

### BACKGROUND

1. Technical Field

The present disclosure relates to information management, and more particularly to an information broker among entities.

2. Discussion of Related Art

Engineering, research or service organizations rely on the expertise and knowledge provided by a skilled work force. Sharing knowledge between experts and groups is one success factor for organizations to operate efficiently, stay innovative and grow. However, growing structures increases the likelihood of communication and collaboration bottlenecks. Thus, finding out who knows what, who is the appropriate person to answer a particular question or who would be the appropriate group to collaborate with on a project becomes increasingly difficult.

### BRIEF SUMMARY

A method for brokering information includes receiving an initiator produced system activity, scoring a relevance of the system activity with each of a plurality of subscriber-specified thresholds, and transmitting an activity response to a subscriber activity feed in response to the system activity, the subscriber activity feed selected according to the relevance of a corresponding subscriber-specified threshold.

A knowledge base system includes a data connection to an initiator device, a non-transitory computer readable medium storing instructions executable by a processor to performed a method for scoring a relevance of a system activity received from the initiator device and determining an activity feed according to the relevance, and a data connection to a receiver, wherein an activity response corresponding to the system activity is placed on the activity feed of the receiver.

### BRIEF DESCRIPTION OF THE DRAWINGS

Preferred embodiments of the present disclosure will be described below in more detail, with reference to the accompanying drawings:

FIG. 1 is a flow diagram of a method according to an embodiment of the present disclosure;

FIG. 2 is an exemplary framework for performing a method according to an embodiment of the present disclosure;

FIG. 3 is a flow diagram of a method according to an embodiment of the present disclosure; and

FIG. 4 is an exemplary computer system for implementing a method according to an embodiment of the present disclosure.

### DETAILED DESCRIPTION OF PREFERRED EMBODIMENTS

According to an embodiment of the present disclosure, an information broker may be disposed between entities for routing questions or comments coming from a user entity to those entities likely to know an answer or likely to be interested in the information. Information routing may be fully automated, without requiring the user entity to self-identify interests, join online groups or purposefully direct incoming and outgoing communications.

According to an embodiment of the present disclosure, knowledge sharing among entities is done automatically and dynamically. Moreover, the groups, message boards and active following/signing up procedures that are required in existing systems may be removed. According to an embodiment of the present disclosure, each action, e.g., message, question, post, etc., is analyzed and automatically matched with one or more entities and groups. An action may then be sent to matched entities and groups. Embodiments of the present disclosure may increase the likelihood that an action, e.g., message, reaches an appropriate entity(ies) and decrease the likelihood that irrelevant messages reach an entity.

Embodiments of the present disclosure include means for enabling entity control of including/excluding messages from a certain entity or containing certain keywords.

The following definitions apply unless explicitly noted in the disclosure. The definitions are non-limiting.

Entity—person or automatic process.

Subscriber—entity of the system for which some Subscriber Data exists.

Subscriber Data—Login name/password, subscriber ID, demographic information, job description, employment history, skills and interests, emails, posts, web history, voice history, system activity history or other information about a Subscriber.

Knowledge Base—A central database system that stores the list of subscribers, subscriber data and the interrelations between Subscriber and subscriber data. The knowledge base may or may not additionally include other information that could be of interest to the subscribers.

System Activity—Queries, broadcasts or updates to a common platform accessible to subscribers.

Activity Feed—Software on an entity's device that displays messages. Information from the activity feed may also be distributed by other communication channels such as email or text messages.

Initiator—An entity that initiates system activity.

Activity Response—The totality of messages sent in response to a system activity to the initiator and possibly other subscribers.

Receiver—A Subscriber to which the activity response is sent.

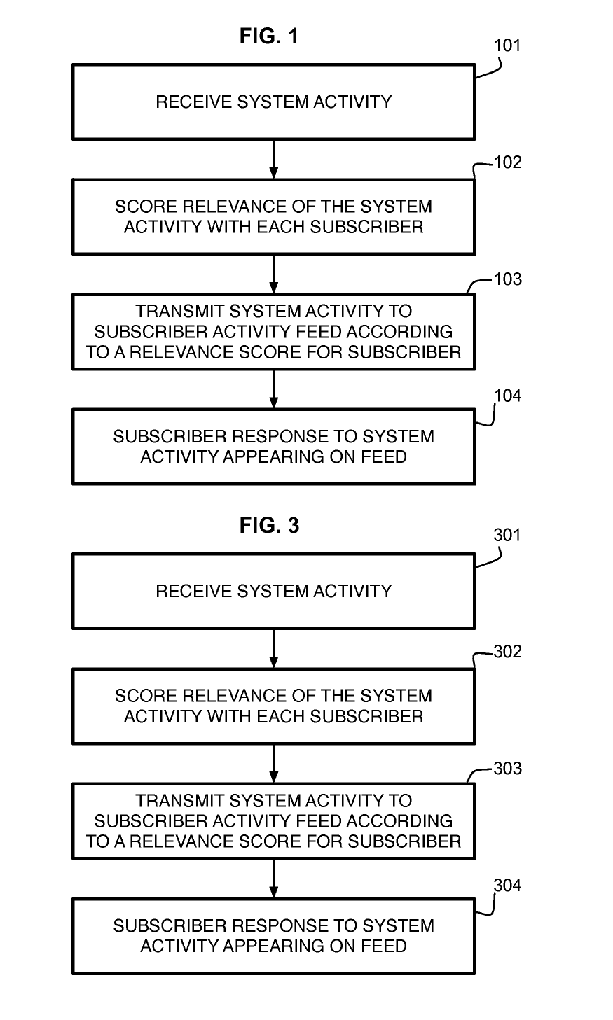

It may be assumed that some subscribers have joined the system and that for each subscriber there is some amount of subscriber data. Referring to FIG. 1, an initiator produces a system activity 101, a learning system assesses or scores the relevance of the system activity with each subscriber 102, the system activity is transmitted to the subscriber's activity feed if the relevance score for the subscriber exceeds a subscriber-specific threshold 103, and subscribers may respond to the system activity appearing on their feed, which is then transmitted to the initiator and logged as activity response 104. A method for brokering information may be embodied as a non-transitory computer readable medium storing instructions executable by a processor.

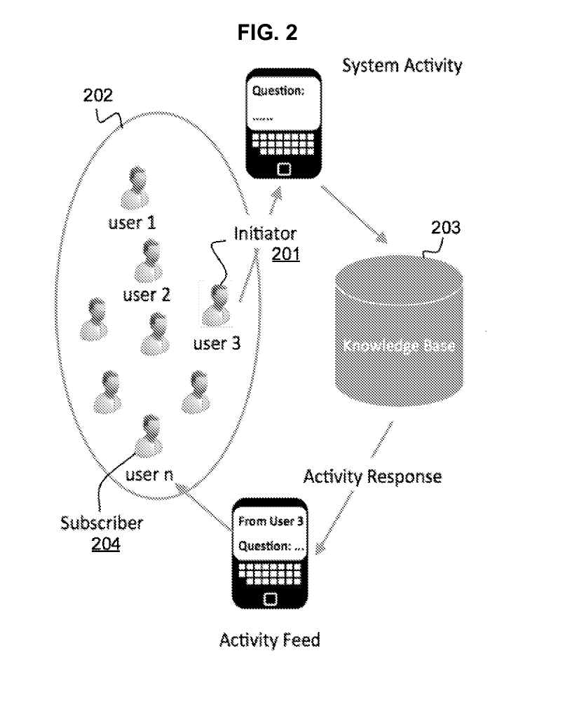

Referring to FIG. 2, the initiator 201 is one among a group of subscribers 202. The system activity of the initiator is communicated to a knowledge base 203, which converts the system activity to a feature vector and determines a score for each subscriber of the group 202. The knowledge base issues an activity response communicated by an activity feed to at least one subscriber 204 among the group 202.

Embodiments of the present disclosure may be implemented on any computational device that is able to connect subscribers (continuously or intermittently) via a messaging system. Example computational devices include (but are not limited to) computers, laptops, DSPs or mobile phones. Example connection devices include (but are not limited to) the Internet, internal networks, servers, LANs, satellite networks or direct connections (wires).

Beyond the core functionality described herein, an exemplary system may also include additional components and functionality. For example, subscribers who have received a system activity may select to monitor the activity response, and subscribers may adjust a corresponding threshold to receive a different set of system activities, e.g., more or less system activities. Further, subscribers may select to receive or ignore system activity that contains one or more subscriber-specified keywords. According to an exemplary embodiment, the system activity may be evaluated against the subscriber-specified keywords, wherein the keywords function as a threshold for controlling a flow of traffic to the subscriber. Subscribers may select to receive or ignore system activity that is initiated by a subscriber-specified Initiator. A subscriber may search for system activity and activity responses that they have received or that are in the system. In addition, the system may generate an activity response to any system activity with relevant information from the knowledge base.

The exemplary additions may be implemented as entity controls or settings, which are adjustable in their system software. The additions may be implemented using a search tool, such as a keyword search tool and the like.

The system may generate an activity response using different approaches, including for example, keyword matching, artificial intelligence, and machine learning solutions. The system may generate possible activity responses that include relevant information from the knowledge base. Each of these possible responses may be given a relevant score from [0,1] and a subscriber-specific threshold would be used to determine if any or all of the possible responses would be added to the activity response. An exemplary method for implementing this component would be to search for all information in the knowledge base that matched the keywords in the system activity and to normalize the frequency of each keyword in the knowledge base to the interval [0,1]. This component may generate its activity responses from information in the knowledge base (e.g., subscriber data or internal information such as a Wiki), previous system activity or activity responses or external information connected to the knowledge base (e.g., external websites). That is, the knowledge base may collect information including system activity and activity responses over time, refining the relevance of activity responses over time by monitoring whether subscribers react to the activity responses generated by the knowledge base on their activity feeds.

Exemplary artificial intelligence and machine learning solutions include Support Vector Machines (SVM), Gaussian mixture models and Bayesian Networks, which take the knowledge base of previous system activities and activity responses as input refine determinations of new activity responses and appropriate activity feeds.

Referring to FIG. 3, the core system may assign each subscriber a unique ID 301, which directs all activity to any feed which matches their ID (which may be multiple feeds). This information may be stored in a database on a centralized or distributed server (e.g., on a hard disk). Subscriber data may be stored in the knowledge base 302. This information may be stored in a database on a centralized or distributed server (e.g., on a hard disk). The activity feed may be implemented as software existing on a device, which may include PCs, laptops, phones, mobile devices that can display and input text. Each system activity and activity response may be logged separately in a display window 303, which may be searched. It should be appreciated that when a receiver reacts to an activity response, e.g., sends an answer to a query, the reaction is in the form of a system activity, which may be scored and put on relevant activity feeds, e.g., the activity feed of the initial initiator.

A method according to an embodiment of the present disclosure may be initiated by having the system react to a system activity of an initiator 304. Each subscriber may have access to a text box with which the user can supply questions/broadcasts. This text box may be accessed by PCs, laptops, phones, mobile devices, etc. Each system activity is assigned an activity ID.

According to an exemplary implementation, keywords (i.e., words in the text) in the system activity may be matched to the frequency of appearance of the keywords in subscriber data 305. The relevance score may be determined as the appearance frequency that has been normalized to the range [0,1]. Common words such as “the”, “is” and “a”, may be excluded from the search. Additional models are contemplated, such as those using natural language processing and/or machine learning are possible. For example, a model may map a system activity as well as the subscriber data into a latent topic space (e.g., using probabilistic topic models such as Latent Dirichlet Allocation (LDA)) to avoid ambiguities and determine the relevance score based on the similarity of both latent representations. In another example, a model may map both system activity and subscriber data into a concept space of known ontologies by extracting concepts and use the distance between the two set of concepts extracted (system activity and subscriber data) to determine the relevance score. In yet another example, a model may combine textual data with social network information from both the subscriber and the recipient to determine the relevance score.

The system activity may be transmitted to a subscriber if the relevance score for the subscriber exceeds the subscriber's threshold 306. Thresholds may be set initially to 0.9, but are subscriber-adjustable. This transmission could be executed via conventional messaging systems (e.g., email, SMS) and/or via system software, which is installed on a user's device, such as (but not limited to) a PC, laptop, phone or mobile device.

A text box may be provided that allows the subscriber to enter messages and store these messages in the activity response associated with the activity ID.

It is to be understood that embodiments of the present disclosure may be implemented in various forms of hardware, software, firmware, special purpose processors, or a combination thereof. In one embodiment, an information broker among entities may be implemented in software as an application program tangibly embodied on a computer readable medium. The application program may be uploaded to, and executed by, a processor comprising any suitable architecture.

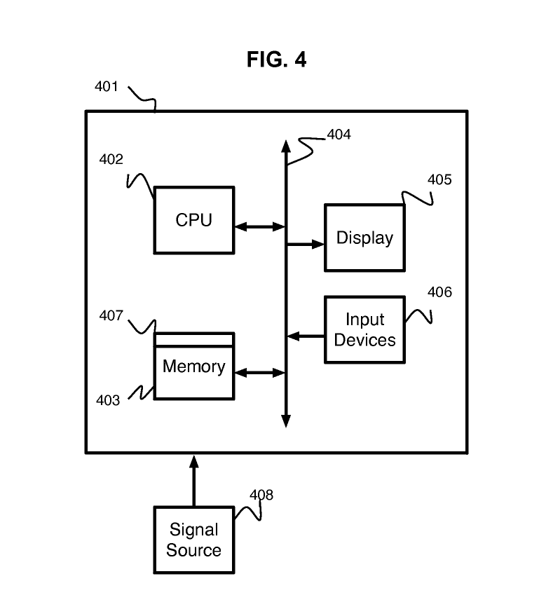

Referring to FIG. 4, according to an embodiment of the present disclosure, a computer system 401 for implementing an information broker among entities can comprise, inter alia, a central processing unit (CPU) 402, a memory 403 and an input/output (I/O) interface 404. The computer system 401 is generally coupled through the I/O interface 404 to a display 405 and various input devices 406 such as a mouse and keyboard. The support circuits can include circuits such as cache, power supplies, clock circuits, and a communications bus. The memory 403 is non-transitory and can include random access memory (RAM), read only memory (ROM), disk drive, tape drive, etc., or a combination thereof. Embodiments of the present disclosure can be implemented as a routine 407 that is stored in memory 403 and executed by the CPU 402 to process the signal from the signal source 408. As such, the computer system 401 is a general-purpose computer system that becomes a specific purpose computer system when executing the routine 407 of the present disclosure.

The computer platform 401 also includes an operating system and micro-instruction code. The various processes and functions described herein may either be part of the micro-instruction code or part of the application program (or a combination thereof) which is executed via the operating system. In addition, various other peripheral devices may be connected to the computer platform such as an additional data storage device and a printing device.

It is to be further understood that, because some of the constituent system components and method steps depicted in the accompanying figures may be implemented in software, the actual connections between the system components (or the process steps) may differ depending upon the manner in which the methods described herein are programmed. Given the teachings of the present disclosure provided herein, one of ordinary skill in the related art will be able to contemplate these and similar implementations or configurations of embodiments described herein.

Having described embodiments for an information broker among entities, it is noted that modifications and variations can be made by persons skilled in the art in light of the above teachings. It is therefore to be understood that changes may be made in embodiments of the present disclosure that are within the scope and spirit thereof.

What is claimed is:

1. A method for brokering information comprising:
receiving an initiator produced system activity;
scoring a relevance of the system activity with each of a plurality of subscriber-specified thresholds; and
transmitting an activity response to a subscriber activity feed in response to the system activity, the subscriber activity feed selected according to the relevance of a corresponding subscriber-specified threshold.

2. The method of claim 1, wherein the scoring is a keyword match method.

3. The method of claim 2, wherein the subscriber-specified threshold specifies a control on the subscriber activity feed to receive or block all system activities including a keyword.

4. The method of claim 1, wherein the subscriber-specified threshold specifies a control on the subscriber activity feed to receive or block all system activities of a specified subscriber.

5. The method of claim 1, wherein the scoring further comprises searching a knowledge base to determine a relevance score for each of the plurality of subscriber-specified thresholds.

6. The method of claim 5, further comprising logging previous system activity in the knowledge base.

7. The method of claim 5, further comprising logging previous activity responses in the knowledge base.

8. The method of claim 1, further comprising:
receiving a response of a subscriber corresponding to the subscriber activity feed; and
transmitting the response to the initiator.

9. The method of claim 8, further comprising logging the response as an activity response.

10. The method of claim 1, further comprising defining a group of subscribers corresponding to the plurality of subscriber-specified thresholds.

11. The method of claim 1, wherein the initiator is a device in communication with the knowledge base embodied as a database and the subscriber activity feed corresponds to at least one receiving device.

12. A non-transitory computer readable medium storing instructions executable by a processor to performed a method for broking information among a group of subscribers, the method comprising:
receiving an initiator produced system activity;
scoring a relevance of the system activity with each of a plurality of subscriber-specified thresholds; and
transmitting an activity response to a subscriber activity feed in response to the system activity, the subscriber activity feed selected according to the relevance of a corresponding subscriber-specified threshold.

13. The computer readable medium of claim 12, wherein the subscriber-specified threshold specifies a control on the subscriber activity feed to receive or block all system activities including a keyword.

14. The computer readable medium of claim 12, wherein the subscriber-specified threshold specifies a control on the subscriber activity feed to receive or block all system activities of a specified subscriber.

15. The computer readable medium of claim 12, wherein the scoring further comprises searching a knowledge base to determine a relevance score for each of the plurality of subscriber-specified thresholds.

16. The computer readable medium of claim 15, further comprising logging previous system activity in the knowledge base.

17. The computer readable medium of claim 15, further comprising logging previous activity responses in the knowledge base.

18. The computer readable medium of claim 12, further comprising:
receiving a response of a subscriber corresponding to the subscriber activity feed; and
transmitting the response to the initiator.

19. The computer readable medium of claim 18, further comprising logging the response as an activity response.

20. A knowledge base system comprising:
a data connection to an initiator device;
a non-transitory computer readable medium storing instructions executable by a processor to performed a method for scoring a relevance of a system activity received from the initiator device and determining an activity feed according to the relevance; and
a data connection to a receiver, wherein an activity response corresponding to the system activity is placed on the activity feed of the receiver.
